(19) United States
(12) Patent Application Publication
(10) Pub. No.: US 2003/0160854 A1
(43) Pub. Date: Aug. 28, 2003

(54) Coating ink jet printed glossy substrates

(76) Inventor: Ralph Paukovits, Clovelly Park (AU)

Correspondence Address: Joseph A Sebolt, Sand & Sebolt, Aegis Tower Suite 1100, 4940 Munson Street NW, Canton, OH, 44718-3615, US

(21) Appl. No.: 10/332,915

(22) PCT Filed: Jul. 16, 2001
(86) PCT No.: PCT/AU01/00862

(30) Foreign Application Priority Data
Jul. 14, 2000 (AU) PQ 8806

(51) Int. Cl. B41J 2/01

(52) U.S. Cl. 347/105

(57) ABSTRACT

The invention concerns a printing process that enables colour printing of high definition and enhanced colour intensity to be achieved with an ink jet printer using standard glossy stock paper and card rather than the more costly photographic quality papers. The process includes applying an image to a glossy substrate using an ink jet printing process, allowing the printed image to dry and subsequently applying a thin film coating of an organic liquid to the image. The organic liquid is preferably a vegetable oil based liquid.

### FIELD OF THE INVENTION

The present invention relates to an improved printing process. In particular, the present invention relates to an improved process for ink jet printing.

### BACKGROUND OF THE INVETION

Ink jet printers have many advantages for both business and home based business printing needs. Ink jet printers are, when compared with other printer types, such as dot matrix printers and laser printers a very acceptable compromise between quality of print and the cost of the print. Importantly, for many users the initial purchase cost of the equipment is significantly lower than laser printers. Ink jet printers are able to produce high-resolution images when compared with those produced by dot matrix printers and at a significantly lower cost than laser printers. It should also be noted that ink jet printers are able to produce colour images much more readily than laser printers, where the initial purchase cost may be an order of magnitude greater than the capital cost of the ink jet printer. For many users of ink jet printers the ability to print full colour images is particularly useful.

For these reasons the adoption of ink jet printers has been widespread and they are found in all spheres of activity from school use, to home, small and large business use.

It has, however, come to the attention of the inventor of the present invention that the colour printing from an ink jet printer on some substrates is disappointing. Ink jet printers operate by producing a stream of charged particles of liquid ink which impact on the paper in an explosive fashion to produce a printed image. The printing process is complete when the ink is dry. In very porous papers the ink spreads slightly ‘bleeding’ outside of the intended printing area thereby causing some blurring of the printed image. To avoid such difficulties the manufacturers of ink jet printers often recommend the use of coated paper if high quality colour definition and colour resolution is needed. Coated paper is often expensive and to a degree, this detracts from the attractiveness of the printer.

The present invention concerns a process for the use of ink jet printers to produce high quality colour images on high gloss print stock such as business cards, cards used in sales promotional material and for other purposes. In such applications a clear striking visual image is preferred.

It has been observed that on glossy stock papers the colour intensity achieved is relatively high when the ink is deposited and gradually declines as the ink dries and ages. The final result is a very much diminished colour intensity and, in some cases a subtle colour change. For example, red often dries to an orangelpink colour, which is unacceptable for reproduction of colour images involving skin tones.

With this in mind the inventor has developed an alternative printing process for use with glossy stock printing substrates.

### SUMMARY OF THE INVENTION

Therefore, according to a first aspect of the present invention, although this need not be the broadest nor indeed the only aspect of the invention there is provided a printing process comprising the steps of:

applying an image to a glossy substrate using an ink jet printing process;

allowing the printed image to dry; and

subsequently applying a thin film coating of an organic liquid to the image.

By applying the organic coating to the surface of the coated product the image is then revived as a full intensity image. The image produces a good quality colour reproduction and Intensity suitable for the true colour reproduction of important documents such as business cards, promotional material and graphic images.

Preferably, the thin film of organic liquid is applied by bringing the glossy printed surface into contact with a cloth impregnated with the organic liquid.

Preferably, the thin film of organic liquid is a non-volatile hydrocarbon, for example a C16-C20 based hydrocarbon or fatty acid. Vegetable oils have been found to be very suitable for use as the organic liquid. For example, oils derived from olive, sunflower, canola, palm, coconut or soy may be used in the present invention.

Alternative organic liquids include mineral spirits such as methylated spirits or mineral turpentine.

It is preferred that the organic liquid is odourless or has an inoffensive odour. This is not an essential feature of the invention but Is more reasonably viewed as a feature that produces a product more suitable for use. Any undesirable odours can be disguised or masked by the inclusion of pleasing aromas such as a lemon fragrance.

The organic liquid may also be supplemented by the inclusion of anti-oxidant material. The substrate material is preferably a card stock having a single glossy side being 150-300 gsm weight. The inventor has found that glossy stock sold as Chromolux of 250/300 gsm is particularly preferred.

### DESCRIPTION OF THE PREFERRED EMBODIMENT

One or more sheets of Chromolux 200 gsm paper were processed through an Epson Stylus Photo 700 printer with a full colour image. The printed document was allowed to dry and subsequently wiped with a cloth previously impregnated with canola oil infused with lemon essence.

A comparison between the image colours between a print treated as described above and an untreated image reveal a sharper, more intense image with more acceptable, realistic colours.

The present invention has been described by way of example only. Modifications and variations of the invention such as would be apparent to a skilled addressee are deemed to be within the scope of the invention.

1. A printing process comprising the steps of:
applying an image to a glossy substrate using an ink jet printing process;
allowing the printed image to dry; and
subsequently applying a thin film coating of an organic liquid to the image.

2. A printing process according to claim 1, characterised in that the thin film of organic liquid is applied by bringing the glossy printed surface into contact with a cloth impregnated with the organic liquid.

3. A printing process according to claim 1, characterised in that the thin film of organic liquid is a non-volatile hydrocarbon, for example a C16-C20 based hydrocarbon or fatty acid.

4. A printing process according to claim 3, characterised in that the organic liquid is a vegetable oil.

5. A printing process according to claim 4, characterised in that the organic liquid comprises one or more oils derived from olive, sunflower, canola, palm, coconut or soy.

6. A printing process according to claim 1, characterised that the organic liquid comprises mineral spirits such as methylated spirits or mineral turpentine.

7. A printing process according to claim 1, characterised in that the organic liquid is odourless or has an inoffensive odour.

8. A printing process according to claim 1, characterised in that the organic liquid further includes odour masking agents or scenting agents.

9. A printing process according to claim 1, characterised in that the organic liquid further includes antioxidant materials.

10. A printing process according to claim 1, characterised in that the glossy substrate comprises a card of 150-300 gsm weight.

11. A printing process according to claim 1, characterised in that the glossy substrate comprises a card of 250-300 gsm weight.
